(19) United States
(12) Patent Application Publication
(10) Pub. No.: US 2013/0279976 A1
(43) Pub. Date: Oct. 24, 2013

(54) INTERLOCKING TAB DEVICE

(71) Applicants: Walter JASICKI, Schomberg (CA); Alexander PUPP, Brampton (CA)

(72) Inventors: Walter JASICKI, Schomberg (CA); Alexander PUPP, Brampton (CA)

(21) Appl. No.: 13/865,390

(22) Filed: Apr. 18, 2013

Related U.S. Application Data
(60) Provisional application No. 61/625,909, filed on Apr. 18, 2012.

(51) Int. Cl. F16B 5/00

(52) U.S. Cl. CPC F16B 5/0084
USPC 403/376

(57) ABSTRACT

An interlocking assembly for joining a first surface and a second surface which consists of an interlocking unit on each surface. Each interlocking unit includes an entry aperture; a locking aperture; and an interlocking tab affixed to an edge of the entry aperture, the interlocking tab comprising a locking member. The units are locked as follows: the interlocking tab of the first interlocking unit fits through the entry aperture of the second interlocking unit and the locking member of the first interlocking unit fits onto the locking aperture of the second interlocking unit; while simultaneously, the interlocking tab of the second interlocking unit fits through the entry aperture of the first interlocking unit and the locking member of the second interlocking unit fits onto the locking aperture of the first interlocking unit.

### TECHNICAL FIELD

The present disclosure relates to the field of joining sheet metal. In particular, the present disclosure relates to a roof curb, and devices used in the assembly thereof.

### BACKGROUND

U.S. Pat. No. 3,926,529 discloses a fastener for connecting two structural members. The device includes a pair of fastener members, each of which is adapted to attach to a structural member and includes bores for interconnecting the members by means of a pin.

U.S. Pat. No. 5,016,406 discloses an interlocking roof curb joint which comprises a male joint member secured to the inner face of a first curb section, and a female joint member secured to the inner face of a second curb section, the male joint member and female joint member being adapted to mate with one another and arrange the first curb section and the second curb section at right angles with one another.

U.S. Pat. No. 5,148,647 discloses a roof mounting curb in which adjacent surfaces are joined with the used of hinge ears (formed within each surface) and a hinge pin inserted into the ears to secure the curb sides to each other.

U.S. Pat. No. 5,188,333 discloses a fastener for attaching a frame onto a roof of a building. The fastener comprises a slot cut into one piece of sheet metal and a dimple and tongue punched out of a second piece of sheet metal. The tongue is slipped into and over the slot until the dimple locks into the slot and thus holds the two pieces of sheet metal together.

U.S. Pat. No. 5,465,533 discloses a modular roof curb assembly construction and interlocking joint means therefor wherein one fastening member is provided integral to a panel member to be fastened to another panel member. A second fastening member is provided having a locking member that intrudes into an opening provided by the integral fastening member. Each fastening member is affixed to adjoining surfaces by screws, or like means.

U.S. Pat. No. 5,896,711discloses a roof curb unit with four side walls, with inserts shaped to conform to the seam geometry that are welded to the walls at the seam locations, typically at opposite corners.

U.S. Pat. No. 6,041,557 discloses assembly apparatus of a roof curb, comprising a set of four cleats, each used to join a corner of the roof curb. Each cleat must be affixed to the adjoining surfaces with a screw, or like means. The tabs of each cleat are fitted into slots on each adjoining surface.

U.S. Pat. No. 7,065,928 discloses roof curb panels formed from flat sheets that are stamped. The panels are attached together via connections that include a bent end on one member panel, which forms a tab, and a strap on another member panel, which receives the tab.

### SUMMARY

Provided herein is an interlocking assembly for joining two surfaces without the need for tools or external fasteners, as the assembly components are integral with each surface.

The interlocking assembly in its general form will first be described, and then its implementation in terms of specific embodiments will be detailed hereafter. These embodiments are intended to demonstrate the principle of the assembly, and the manner of its implementation. The interlocking assembly in its broadest and more specific forms will then be further described, and defined, in each of the individual claims which conclude this specification.

In one aspect of the present invention, there is provided an interlocking assembly for joining a first surface and a second surface, the interlocking assembly consisting of an interlocking unit on each surface, each interlocking unit comprising: a) an entry aperture; b) a locking aperture; c) an interlocking tab affixed to an edge of the entry aperture, the interlocking tab comprising a locking member; wherein: simultaneously, the interlocking tab of the first interlocking unit fits through the entry aperture of the second interlocking unit and the locking member of the first interlocking unit fits onto the locking aperture of the second interlocking unit; and the interlocking tab of the second interlocking unit fits through the entry aperture of the first interlocking unit and the locking member of the second interlocking unit fits onto the locking aperture of the first interlocking unit.

The first and second surface may each comprise sheet metal, so that interlocking unit is stamped onto the sheet metal of each surface. Furthermore, the interlocking assembly may be used for interlocking two adjacent surfaces of a roof curb.

The foregoing summarizes the principal features of the interlocking assembly and some of its optional aspects. The interlocking assembly may be further understood by the description of the embodiments which follow.

### BRIEF DESCRIPTION OF DRAWINGS

FIGS. 1A and 1B respectively illustrate two views of an embodiment of an interlocking device.

FIG. 2 illustrates assembly of two identical interlocking devices shown in FIG. 1

FIGS. 3A-3C illustrate assembly to two adjacent roof curb surfaces, using the embodiment shown in FIG. 1.

FIGS. 4A-4C illustrate a cross-sectional plan view of other embodiments of the interlocking assembly.

FIGS. 5A-5C illustrate a cross-sectional plan view of the mating of two identical interlocking assemblies shown in FIG. 4A.

### DETAILED DESCRIPTION OF PREFERRED EMBODIMENTS

The following is given by way of illustration only and is not to be considered limitative. Many apparent variations are possible without departing from scope of the interlocking assembly.

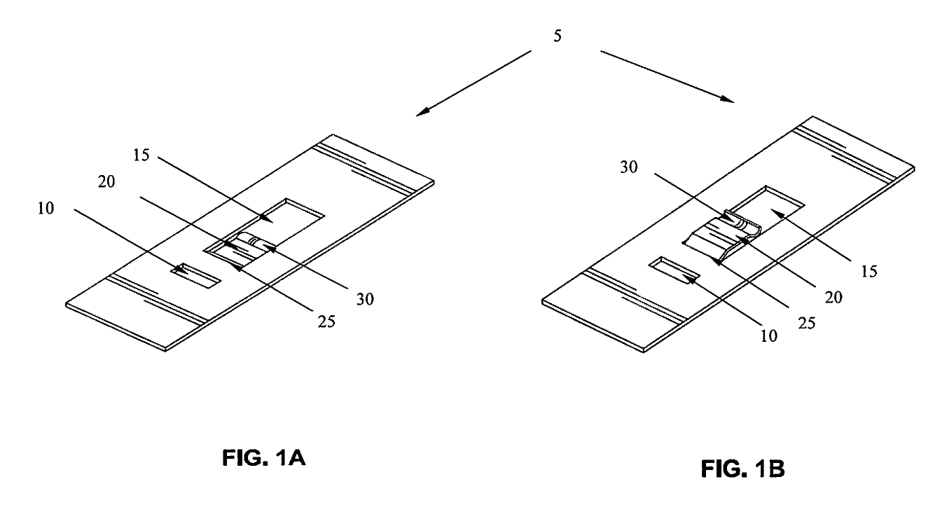

In one embodiment, the interlocking assembly comprises a pair of identical fastener units stamped into the adjoining surfaces of a roof curb, as shown in FIG. 1A.

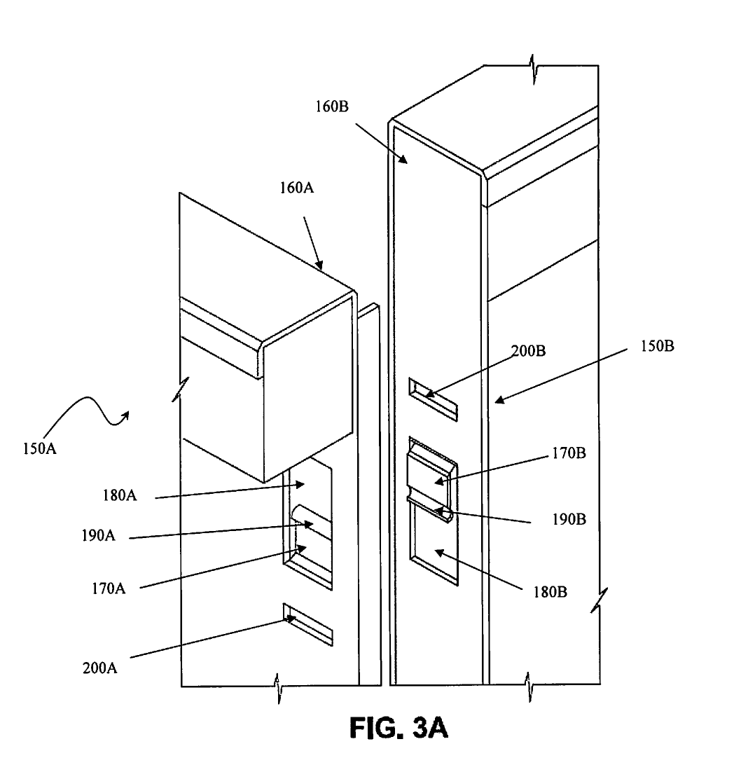

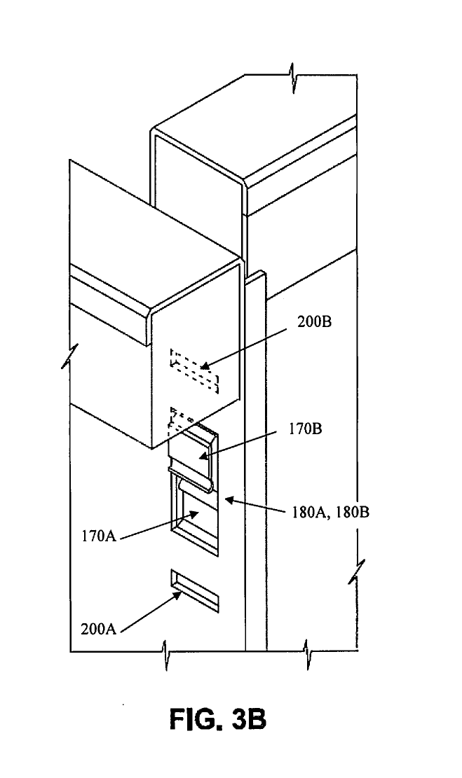

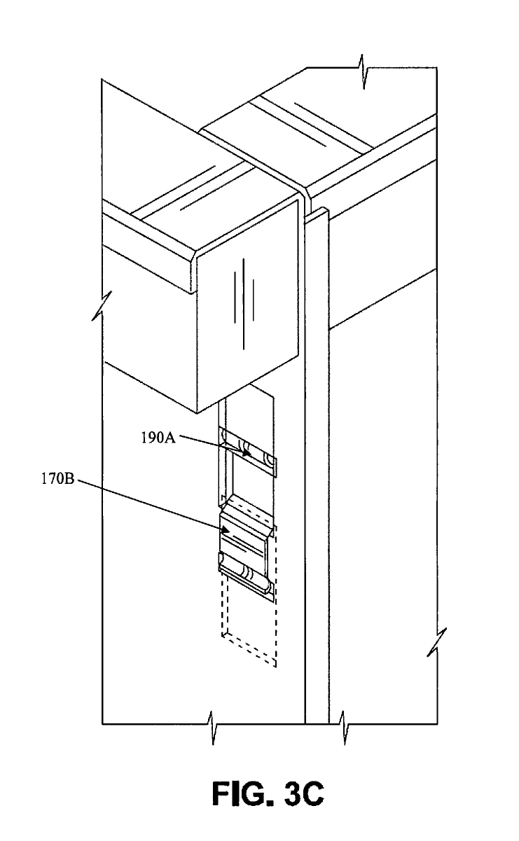

FIG. 1A illustrates an embodiment of an interlocking device. The unit is actually stamped into a surface of the roof curb, as is shown in FIGS. 3A to 3C. The embodiment shown in FIG. 1A is separated from the roof curb surface for illustrative purposes only. FIG. 1B illustrates the assembly of FIG. 1A flipped over the horizontal plane of the unit.

Each fastener (5) unit includes two apertures (10, 15): locking aperture (10); and an entry aperture (15) that has an integral tab (20) attached at one edge (25) thereof. The tab (20) extends slightly below the plane of the entry aperture(15). In addition, the tab (20) has a locking member (30) at the end opposite the line (25) joining the tab (20) and the entry aperture (15). Each fastener (5) unit can be made of sheet metal, and all components (slots, tab) are stamped out of the sheet metal.

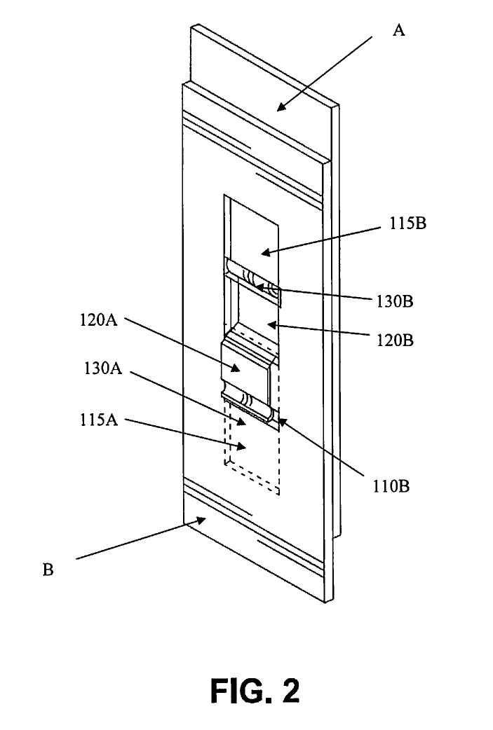

FIG. 2 illustrates the mating of two fasteners (A, B). The tab (120A) of the fastener A enters the entry aperture (115B) of fastener B, while the locking member (130A) of fastener A locks onto the locking aperture (110B) of fastener B. Simultaneously, the tab (120B) of fastener B enters the entry aperture (115A) of fastener A. The entry aperture (115A) of fastener A is slightly obscured, as it hidden under fastener B. The locking member (130B) of fastener B locks onto locking aperture (110A) of fastener A.

The contemplated use of two fasteners (A, B) is shown in FIGS. 3A-3C. Two surfaces (160A, 160B), each made of sheet metal, are to be joined together. Each surface (160A, 160B) has a respective fastener unit (150A, 150B) stamped thereunto. As each surface (160A, 160B) is brought together, the fastener units (150A, 150B) are attached to each other in the manner described by the sequence of FIGS. 3A-3C.

The tab (170A) of the fastener unit A fits through the entry aperture (180B) of fastener unit B, while simultaneously, the tab (170B) of fastener unit B fits through the entry aperture (180A) of fastener unit A. The two units (150A, 150B) are then moved parallel to each other, until the locking member (190A) of unit A latches onto the locking aperture (200B) of unit B. Simultaneously, the locking member (190B) of unit B latches onto the locking aperture (200A) of unit A. A snug connection between the two surfaces (160A, 160B) is provided by the interlocking connection, without any need of bolts, screws, or the like.

The locking member can have any shape, so long as it fits snugly into the opposing locking aperture. While a concave form is shown in the Figures, the locking member can have, for example, a hook shape that fits through the locking aperture.

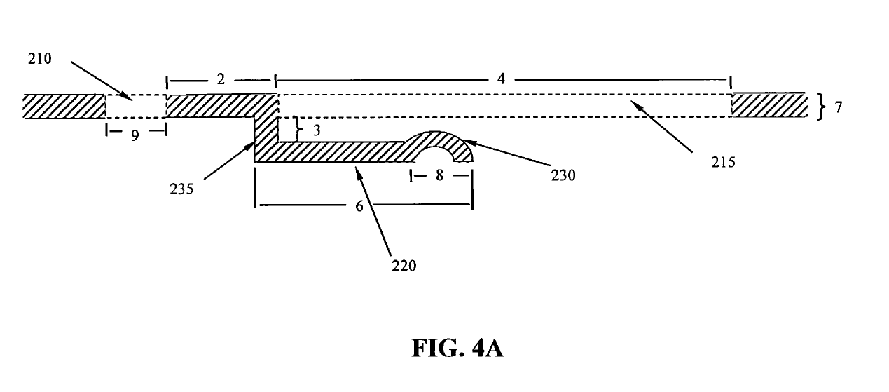

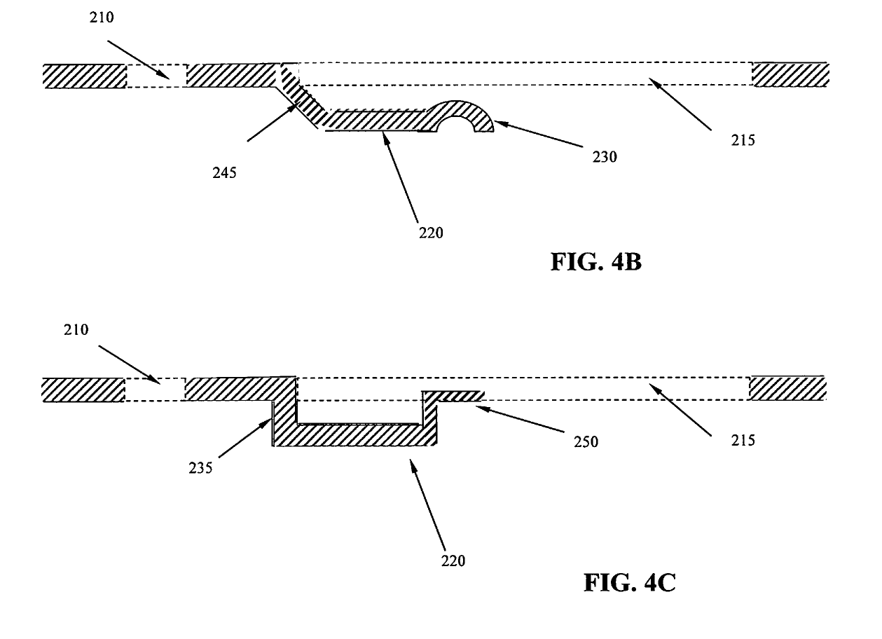

In FIG. 4A, another embodiment of the interlocking assembly mechanism is shown in a cross-sectional view. The assembly has a locking aperture (210), entry aperture (215), tab (220), locking member (230), and tab connector (235). In the embodiment shown in FIGS. 1-3, the tab connector is at an angle, whereas in the embodiment shown in FIG. 4A, the tab connector (235) is perpendicular to the plane of the surface containing the interlocking assembly mechanism. In addition, while the locking member (230) assumes a concave-like structure, it is understood that other suitable shapes or structures may be used, such as, but not limited to, a hook or a second, smaller tab. FIG. 4A also illustrates the various dimensions of the components: the locking aperture length (9); the entry aperture length (4); the tab length (6); the locking member length (8); the thickness(7) of the sheet containing the assembly; the height (3) of the space between the tab (220) and the entry aperture (215); and the distance (2) between the entry aperture (215) and locking aperture (210).

In order for two sheets with the interlocking assembly to mate, there are certain conditions between the various dimensions. The entry aperture length (4) must be at least twice the tab length (6), and can be at minimum equal to the tab length (6), so that the tab of each mating assembly can enter into the entry aperture of the complimentary assembly. In addition, the the tab length (6) is greater than, or equal to, the distance (2). When the tab length (6) is equal to the distance (2), then the tab of a second sheet will fit up right against the tab connector (235). In addition, the thickness of the sheet (7) must be less than or equal to the height of space (6).

FIGS. 4B and 4C illustrate minor variations of the embodiment shown in FIG. 4A. For example, in FIG. 4B, the tab connector (245) is slanted, and in FIG. 4C, the locking member (250) is in the shape of a tab fitted for insertion into a complimentary locking aperture.

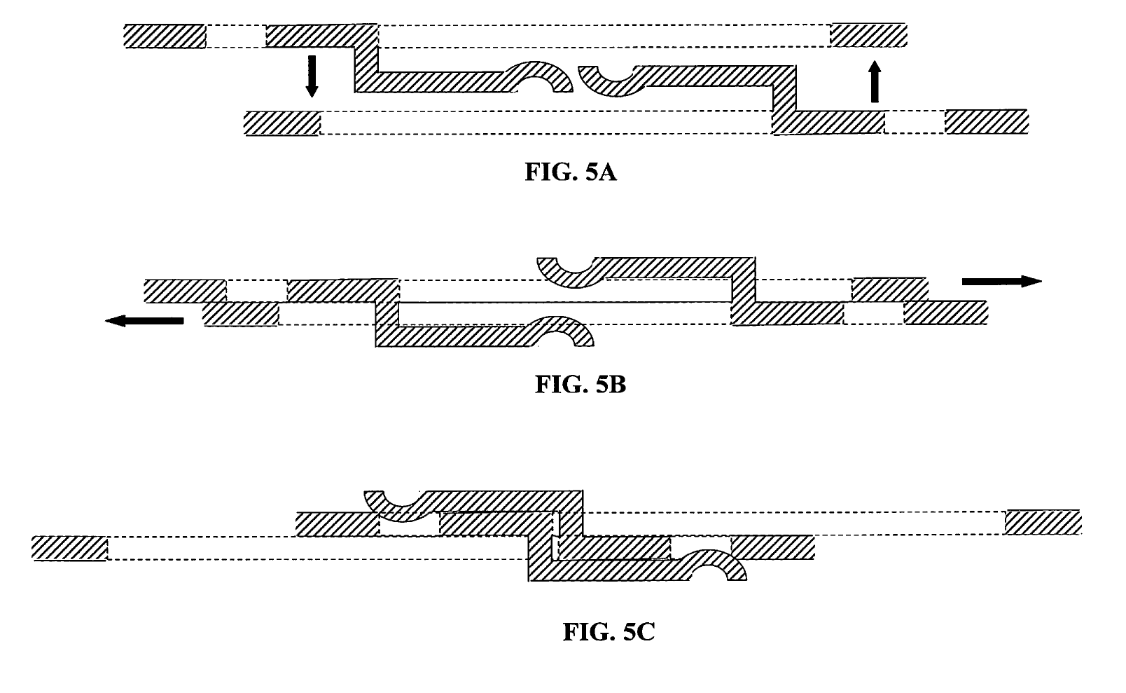

FIGS. 5A-5C illustrate the mating of two interlocking assemblies illustrated in FIG. 4A.

Wherever ranges of values are referenced within this specification, sub-ranges therein are intended to be included within the scope of the interlocking assembly unless otherwise indicated. Where characteristics are attributed to one or another variant, unless otherwise indicated, such characteristics are intended to apply to all other variants where such characteristics are appropriate or compatible with such other variants.

### CONCLUSION

The foregoing has constituted a description of specific embodiments showing how the interlocking assembly may be applied and put into use. These embodiments are only exemplary. The interlocking assembly in its broadest, and more specific aspects, is further described and defined in the claims which now follow.

1. An interlocking assembly for joining a first surface and a second surface, the interlocking assembly consisting of an interlocking unit on each surface, each interlocking unit comprising:
a. an entry aperture;
b. a locking aperture;
c. a tab connector;
d. an interlocking tab affixed to an edge of the entry aperture via the tab connector, the interlocking tab comprising a locking member;
wherein:
simultaneously, the interlocking tab of the first interlocking unit fits through the entry aperture of the second interlocking unit and the locking member of the first interlocking unit fits onto the locking aperture of the second interlocking unit; and the interlocking tab of the second interlocking unit fits through the entry aperture of the first interlocking unit and the locking member of the second interlocking unit fits onto the locking aperture of the first interlocking unit.

2. The interlocking assembly of claim 1, wherein the first and second surface each comprises sheet metal, and each interlocking unit is stamped onto each surface.

3. The interlocking assembly of claim 2, wherein each surface forms part of a roof curb.

4. The interlocking assembly of claim 1, wherein the tab connector is perpendicular to a plane of the entry aperture.

5. The interlocking assembly of claim 1, wherein the locking member has a surface concave to a plane of the entry aperture.

6. The interlocking assembly of claim 1, wherein the locking member has a hook or tab structure.

7. The interlocking assembly of claim 1, wherein a length of the entry aperture is equal to at least twice a length of the interlocking tab.

8. The interlocking assembly of claim 7, wherein the length of the entry aperture is equal to twice the length of the interlocking tab.

9. The interlocking assembly of claim 1, wherein a distance between the entry aperture and the locking aperture is at least less than or equal to a length of the interlocking tab.

10. The interlocking assembly of claim 9 wherein the distance between the entry aperture and the locking aperture is at equal to the length of the interlocking tab.

11. The interlocking assembly of claim 1, wherein a thickness of each surface is less than or equal to a distance between an upper plane of the interlocking tab and a lower plane of the entry aperture.

12. The interlocking assembly of claim 11, wherein the thickness of each surface is equal to a distance between the upper plane of the interlocking tab and the lower plane of the entry aperture.
